(19) United States
(12) Patent Application Publication
(10) Pub. No.: US 2013/0178766 A1
(43) Pub. Date: Jul. 11, 2013

(54) COVER FOR THERAPEUTIC ROLLER AND METHOD

(71) Applicant: Jamil Abdur-Raoof, Rockville, MD (US)

(72) Inventor: Jamil Abdur-Raoof, Rockville, MD (US)

(21) Appl. No.: 13/345,240

(22) Filed: Jan. 6, 2012

(51) Int. Cl. A61H 1/00; B05C 11/00

(52) U.S. Cl. 601/19; 492/48

(57) ABSTRACT

A cover for a therapeutic roller for manipulating soft tissue and a method of using same are provided. The cover can include a main wrapping member including a sheet of material including a first end and a second end. At least one pocket can be arranged on the sheet of material and each pocket can be adapted to receive a replaceable article. A first fastening portion can be arranged on the first end of the sheet of material and a complimentary second fastening portion can be arranged on the second end of the sheet of material. The main wrapping member is securable to the therapeutic roller by wrapping the cover around the therapeutic roller and bringing the first fastening portion into contact with the second fastening portion whereby the main wrapping member is adapted to extend about the circumferential surface of the therapeutic roller.

### FIELD OF THE INVENTION

The present teachings relate to improvements in devices and methods for treating and preventing common injuries seen in athletes. In particular, the present teachings relate to a cover for a therapeutic roller which allows the addition of a heating and cooling dimension when using the roller to roll out.

### BACKGROUND OF THE INVENTION

Vigorous stretching for athletes is very beneficial and cannot be neglected. In the case of muscle knots however, stretching alone is not always enough. When stretching a muscle having knots, the athlete is generally only stretching the healthy muscle tissue while substantially neglecting the knot. The knot will remain a knot while the rest of the muscle is stretched.

An effective way of attacking a troublesome muscle knot is by the application of direct pressure. A well-trained massage therapist can effectively apply pressure to break-up and relieve muscle knots. However, muscle knots can be pesky and it can take several treatment sessions to fix a well-placed knot. Moreover, it is not uncommon for muscle knots to keep recurring again and again when least expected.

A highly-effective, yet economical way to eliminate and prevent muscle knots is through the use of a foam roller. A foam roller is a firm foam cylinder usually having a diameter of about 6 inches. In use, the foam roller is rolled against the user's muscle knots using their own body weight to generate the direct pressure. The idea is similar to using a rolling pin to roll out lumps in bread dough. A foam roller is a good alternative to repetitive trips to the massage therapist and is a highly-effective way to treat and prevent the most common injuries seen in runners.

Rolling out can be performed before and after rehabbing a particular muscle group, such as the hamstring. The muscle group at issue is first heated to warm-up the muscles before subsequently rolling out the muscle. When the rehab session on the muscle group is completed, rolling out is performed again for a second time after which ice is applied to reduce or prevent swelling. By rolling out twice, once before rehabbing the muscle group and once after rehabbing, in conjunction with the additional heating and cooling application steps, the build-up of scar tissue can be prevented. However, such a multi-stepped rehabilitation process can be tedious and time-consuming.

Accordingly, there exists a need for a device that can allow a user to simultaneously manipulate soft tissue while adding a heating and cooling dimension to thereby provide a deeper and long-lasting massaging effect.

### SUMMARY OF THE INVENTION

The present teachings provide a cover for a therapeutic roller for manipulating soft tissue. The cover includes a main wrapping member including a sheet of material including a first end and a second end, at least one pocket arranged on the sheet of material, each pocket being adapted to receive a replaceable article, and a first fastening portion arranged on the first end of the sheet of material and a complimentary second fastening portion arranged on the second end of the sheet of material. The main wrapping member is securable to the therapeutic roller by wrapping the cover around the therapeutic roller and bringing the first fastening portion into contact with the second fastening portion whereby the main wrapping member is adapted to extend about the circumferential surface of the therapeutic roller.

The present teachings also provide a therapeutic roller and cover. The therapeutic roller is formed in the shape of a cylinder defined by a diameter and a length. A main wrapping member includes a sheet of material including a first end and a second end, at least one pocket arranged on the sheet of material, each pocket being adapted to receive a replaceable article, and a first fastening portion arranged on the first end of the sheet of material and a complimentary second fastening portion arranged on the second end of the sheet of material. The main wrapping member is securable to the therapeutic roller by wrapping the member around the therapeutic roller and bringing the first fastening portion into contact with the second fastening portion whereby the main wrapping member is shaped to extend about the circumferential surface of the therapeutic roller.

The present teachings still further provide a method of rolling out using a heating and cooling dimension. The method includes providing a therapeutic roller formed in the shape of a cylinder defined by a diameter and a length and including a circumferential surface. The method further includes providing a cover for the therapeutic roller including at least one pocket adapted to receive one of a heating and cooling article and placing a replaceable article into the at least one pocket of the cover. The method still further includes securing the cover to the circumferential surface of the therapeutic roller and rolling the covered therapeutic roller against one's body using one's own body weight to generate direct pressure.

Additional features and advantages of various embodiments will be set forth, in part, in the description that follows, and will, in part, be apparent from the description, or may be learned by the practice of various embodiments. The objectives and other advantages of various embodiments will be realized and attained by means of the elements and combinations particularly pointed out in the description herein.

### BRIEF DESCRIPTION OF THE DRAWINGS

FIG. 1 shows a top side perspective view of a cover for a roller according to the present teachings;

FIG. 2 shows a bottom side perspective view of a cover for a roller according to the present teachings;

FIG. 3 shows a perspective view of a replaceable article for use with the cover of FIGS. 1 and 2;

FIG. 4 shows a perspective view of a typical roller for use with the cover of FIGS. 1 and 2;

FIG. 5 shows a perspective view of the cover of FIGS. 1 and 2 secured about the circumference of a typical roller in an operative position;

FIG. 6 shows a covered roller being used to perform an IT band roll;

FIG. 7 shows a covered roller being used to perform a hamstring/quad roll; and

FIG. 8 shows a covered roller being used to perform a hamstring/quad roll.

It is to be understood that both the foregoing general description and the following detailed description are exemplary and explanatory only, and are intended to provide an explanation of various embodiments of the present teachings.

### DETAILED DESCRIPTION OF THE PREFERRED EMBODIMENTS

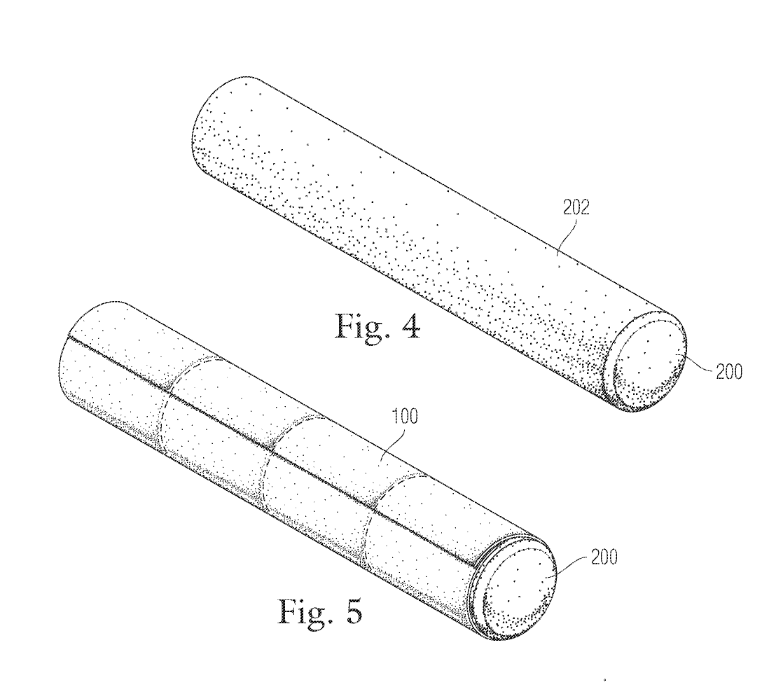

The present teachings relate to a cover for a therapeutic roller used to manipulate soft tissue. Rollers are generally used as part of a muscle recovery or regeneration plan. A roller can be made of various materials but is commonly made of foam and then referred to as a foam roll or a foam roller. A typical roller is a cylindrical piece of tightly packed foam that can be about 6 inches in diameter and typically between about 1 foot and about 3 feet long. Such a roller 200 is shown in FIG. 4.

The cover 100 of the present teachings can be configured to secure about the circumferential surface 202 of a roller 200 and includes one or more mechanisms for receiving and securing heat or cold packs, or any desired heating or cooling medium to the circumferential surface 202 of the roller 200. The cover 100 of the present teachings allows the user to add a heating and cooling dimension when rolling out to achieve a deeper and long-lasting massaging effect.

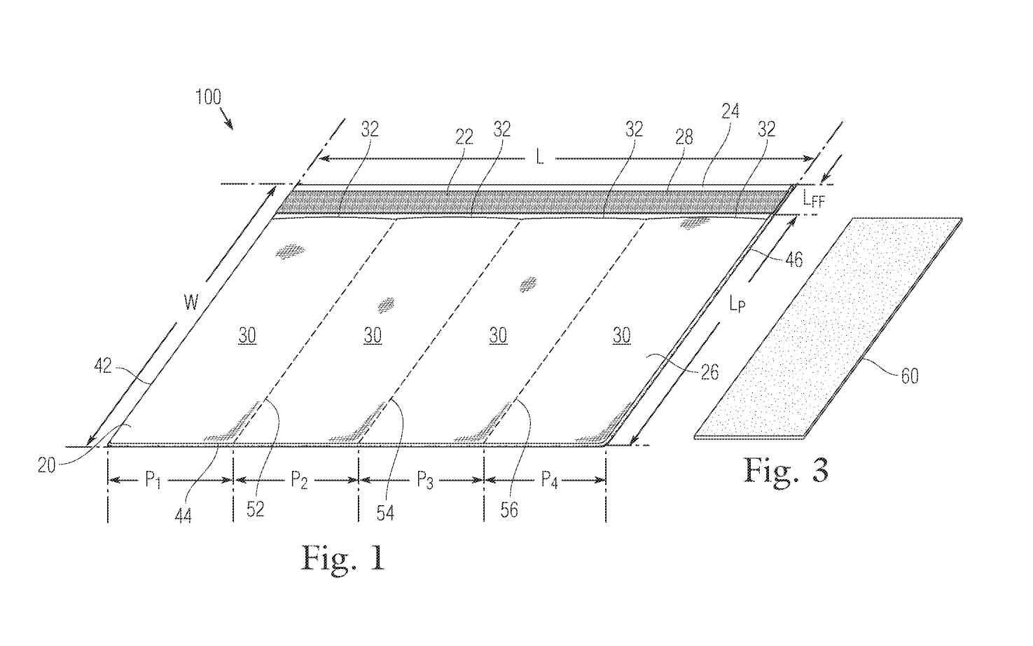

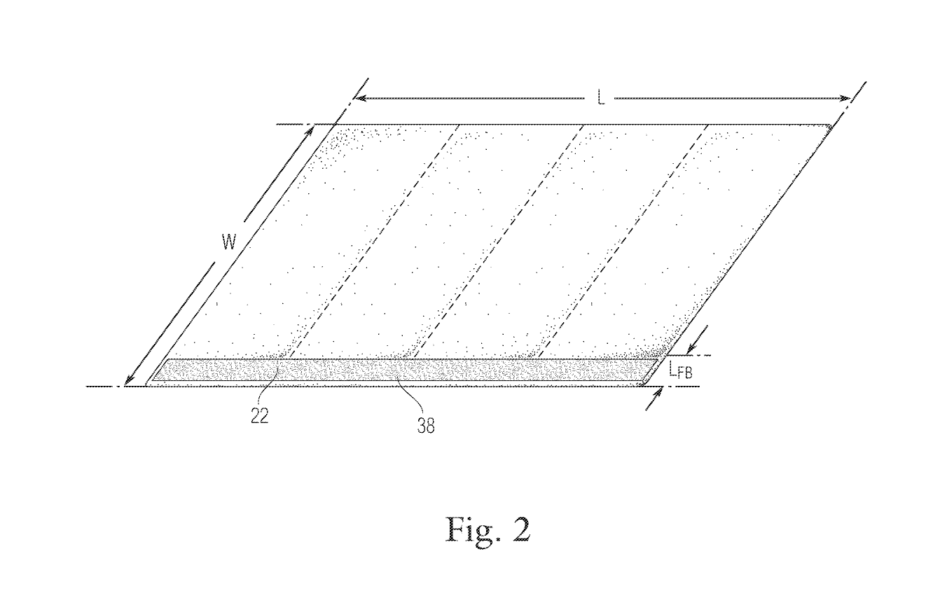

FIGS. 1 and 2 show a top side and a bottom side, respectively, of a cover 100 for a roller 200 according to the present teachings. The cover 100 is shown in a full flat-out position and includes a main wrapping member 20 that can include one or more pockets 30 arranged on one side thereof. The cover 100 can include a plurality of fastening portions 22 to enable the cover 100 to be tightly affixed about the circumferential surface of the roller 200. In this regard, the fastening portions 22 can be arranged substantially at the edges of the main wrapping member 20 and on opposite sides thereof.

As shown in FIG. 1, the fastening portions 22 can include a first part of a hook-loop fastener 28 arranged on a top side of the main wrapping member 20 while FIG. 2 shows a second part of a hook-loop fastener 38. Now referring to FIG. 5, upon wrapping the main wrapping member 20 around the roller 200, the first and second fastener parts 28, 30 are capable of mating and securing the main wrapping member 20 about the circumferential surface 202 of the roller 200. While the fastening portions 22 have been described and shown as a hook and loop fastening system, any fastening mechanism can be implemented with the cover 100 of the present teachings. For example, the fastening mechanism can include snaps, buttons, belts, and the like.

The main wrapping member 20 can be made of one or more sheets of a woven fabric, knit fabric, or a special nonwoven fabric that can be stretchable. Other materials having the requisite mechanical properties are also suitable such as plastics. The main wrapping member 20 can be reusable, but can be disposed of after a period of time (e.g., about 4 to 8 months depending on the amount of use) when it begins to lose elasticity or shows wear.

The one or more pockets 30 can be integrally formed on the cover 100 or can be separately attached to the cover 100 by way of, for example, sewing, gluing, or using mechanical fasteners. Each of the pockets 30 can have an opening, such as opening 32. As shown in FIG. 1, the main wrapping member 20 can be made from two fabric sheets including a base sheet 24 and a smaller pocket-forming sheet 26 arranged on top of the base sheet 24. The smaller pocket-forming sheet 26 can be secured to the base sheet 24 by any attachment method such as by sewing, gluing, clasping, and the like. For example, the smaller pocket-forming sheet 26 can be sewn into the base sheet 24 along a periphery thereof along three sides 42, 44, 46 of the main wrapping member 20. The individual pockets 30 can be formed by stitching at locations 52, 54, 56 at points along the length L of the wrapping member 20 thereby defining the openings 32 of each of the pockets 30.

While the pockets 30 are shown arranged on the outer side of the cover 100 as shown in FIG. 1, the pockets 30 could be alternatively arranged on the inner side of the cover 100, or on both the outer and inner sides of the cover 100. Moreover, while the main wrapping member 20 and pockets 30 are shown being formed by two sheets 24, 26, any combination of sheets can be implemented. Alternatively, each of the pockets 30 can be individually formed and separately attached to the base sheet 24.

The one or more pockets 30 can be shaped to receive and hold one or more replaceable articles 60. The replaceable article 60 can be a heating article such as a thermal pack or a cooling article such as a cooling pack. The replaceable article 60 could be any other therapeutic article. The heating or cooling article can be any heat generating or cooling pack known in the art, and can be available in various sizes and constructions. The heating or cooling article can be sized and shaped so as to fill out as much of each individual pocket 30 as possible so as to extend about the entire circumferential surface 202 of the roller 200 in an operative position of the cover 100. In order to possess a size so as to fill out a pocket 30, a cooling pack can be formed from one or more ice blankets that have been secured together.

Alternatively, dried rice or corn can be used as the heating or cooling articles. The dried rice or corn can be arranged in each pocket 30 and the pocket 30 closed such as by sewing or any other securing method. When needed, the cover 100 filled with rice and/or corn can either be heated and used in place of a thermal pack or be frozen and used in place of an ice pack. The corn can be organic and a high-density hybrid corn. The rice can be organic and a moist rice.

When the replaceable article 60 is expended, it can be removed from the pocket 30 and replaced with a new article 60. The replaceable article 60 can be secured within the pocket 30 by the addition of a mechanical or adhesive fastening system, but can also be retained by cover 100 in the pocket 30 simply as a result of contractive forces and friction. Alternatively, the replaceable article 60 can be affixed to the pocket 30 by employing a mechanical or adhesive fastening system as when rice or corn is sewn or otherwise fastened into the respective pockets. Each pocket 30 can be divided up into one or more subpockets so as to more evenly secure the heating and cooling articles.

Once the one or more replaceable articles 60 are secured within the pockets 30 of the cover 100 of the present teachings, the cover 100 can be attached to the roller 200. The cover 100 can then be wrapped about the circumferential surface 202 of the roller 200 with the end of the cover 100 bearing fastener portion 38 being wrapped around the roller 200 as the final step. The cover 100 is secured to the roller 200 by bringing the surface of fastener portion 28 into contact with the exposed surface of fastener portion 38, enabling the hook and loop fastening members to engage. The cover 100 of the present teachings is then securely affixed to the roller 200. FIG. 5 is a perspective view of the cover 100 operatively secured about the circumferential surface of a foam roller 200.

While the cover 100 is depicted in FIGS. 1 and 2 as having a simple rectangular shape, the cover 100 can be constructed in any desired length, L, and width, W, or in any shape or configuration, so as to be securely mountable to rollers of various sizes. For example, for a typical foam roller having a 6 inch diameter and a length of about 36 inches, the main wrapping member 20 can have a length L, of about 36 inches, and a width, W, of about 22 inches. Moreover, the pockets 30 can each have a width of P₁=about 8 inches, P₂=about 9 inches, P₃=about 9 inches, and P₄=about 8 inches and a length Lₚ=about 21.5 inches. This then leaves a length L_{FF}=about 3.5 inches for the top-side fastening portion 22. Referring to FIG. 2, a corresponding length L_{FB}=about 2.5 inches can be arranged on the bottom side of the cover for the complimentary bottom-side fastening portion 22.

Depending on whether heating articles or cooling articles have been inserted into the pockets 30 of the cover 100 of the present teachings, the foam roller 200 can now be used to improve muscle warming-up and cooling down procedures and to provide a deeper massage while also eliminating and preventing muscle knots. This can be achieved by using the covered roller to roll back and forth across the painful or still area for a period of time, such as, for example, 60 seconds. Extra time can be spent rolling out directly over any knots or trigger points.

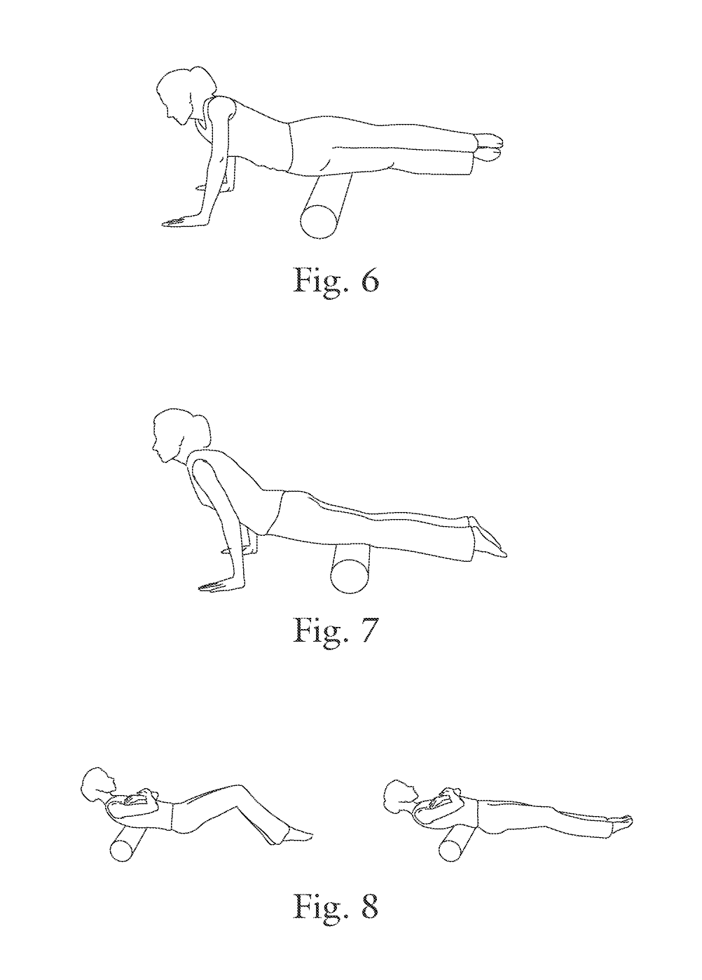

FIGS. 6 to 8 show various exercises being performed using the covered foam roller of FIG. 5 to target various muscle groups.

FIG. 6 shows the covered foam roller being used to perform an IT band roll. In this exercise, the user lies sideways with the foam roller under the side of their thigh. The user then moves so as to roll the foam roller between the knee and hip bone.

FIG. 7 shows the covered foam roller being used to perform a hamstring/quad roll. In this exercise, the user starts with both of their thighs on the roller at the same time. The user then rolls back and forth from their knees to their hips. To increase the pressure, one thigh can be lifted off the roller. While FIG. 5 shows the user with the front side of the thighs touching the roller, the exercise can also be performed with the back side of the thighs being on the roller.

FIG. 8 shows the covered foam roller being used to perform a middle back roll. In this exercise, the user lies on their back on the foam roller. The user crosses their arms across the front of their chest and exhales deeply as they roll the middle of their back against the roller.

Those skilled in the art can appreciate from the foregoing description that the present teachings can be implemented in a variety of forms. Therefore, while these teachings have been described in connection with particular embodiments and examples thereof, the true scope of the present teachings should not be so limited. Various changes and modifications may be made without departing from the scope of the teachings herein.

What is claimed is:

1. A cover for a therapeutic roller for manipulating soft tissue comprising:
a main wrapping member including;
a sheet of material including a first end and a second end;
at least one pocket arranged on the sheet of material, each pocket being adapted to receive a replaceable article; and
a first fastening portion arranged on the first end of the sheet of material and a complimentary second fastening portion arranged on the second end of the sheet of material;
wherein the main wrapping member is securable to the therapeutic roller by wrapping the cover around the therapeutic roller and bringing the first fastening portion into contact with the second fastening portion whereby the main wrapping member is adapted to extend about the circumferential surface of the therapeutic roller.

2. The cover of claim 1, wherein the at least one pocket is adapted to extend about substantially an entire circumference of the therapeutic roller when the main wrapping member is secured to the therapeutic roller.

3. The cover of claim 1, wherein the replaceable article is one of a heating and cooling article.

4. The cover of claim 1, wherein the replaceable article is corn.

5. The cover of claim 1, wherein the sheet of material is a rectangular sheet of material.

6. The cover of claim 1, wherein the main wrapping member includes the sheet of material and a pocket-forming sheet arranged on the sheet of material.

7. The cover of claim 1, wherein the at least one pocket is arranged on an exterior side of the sheet of material.

8. A therapeutic roller and cover comprising:
a therapeutic roller formed in the shape of a cylinder defined by a diameter and a length;
a main wrapping member including;
a sheet of material including a first end and a second end;
at least one pocket arranged on the sheet of material, each pocket being adapted to receive a replaceable article; and
a first fastening portion arranged on the first end of the sheet of material and a complimentary second fastening portion arranged on the second end of the sheet of material;
wherein the main wrapping member is securable to the therapeutic roller by wrapping the member around the therapeutic roller and bringing the first fastening portion into contact with the second fastening portion whereby the main wrapping member is shaped to extend about the circumferential surface of the therapeutic roller.

9. The cover of claim 8, wherein the at least one pocket is shaped to extend about substantially the entire circumference of the therapeutic roller when the main wrapping member is secured to the therapeutic roller.

10. The cover of claim 8, wherein the replaceable article is one of a heating and cooling article.

11. The cover of claim 8, wherein the replaceable article is corn.

12. The cover of claim 8, wherein the sheet of material is a rectangular sheet of material.

13. The cover of claim 8, wherein the main wrapping member includes the sheet of material and a pocket-forming sheet arranged on top of the sheet of material.

14. The cover of claim 8, wherein the at least one pocket is arranged on an exterior side of the sheet of material.

15. A method of rolling out using a heating and cooling dimension;
providing a therapeutic roller formed in the shape of a cylinder defined by a diameter and a length and including a circumferential surface;
providing a cover for the therapeutic roller including at least one pocket adapted to receive one of a heating and cooling article;
placing a replaceable article into the at least one pocket of the cover;
securing the cover to the circumferential surface of the therapeutic roller; and
rolling the covered therapeutic roller against one's body using one's own body weight to generate direct pressure.

16. The method of claim 15, wherein the at least one pocket of the cover is adapted to extend about an entire circumference of the therapeutic roller when the cover is secured to the therapeutic roller.

17. The method of claim 15, wherein the replaceable article is one of a heating and cooling article.

18. The method of claim 15, wherein the replaceable article is corn.

19. The method of claim 15, wherein the cover is a rectangular sheet of material.

20. The method of claim 15, wherein the at least one pocket is arranged on an exterior side of the sheet of material.
